(19) United States
(12) Patent Application Publication
(10) Pub. No.: US 2020/0236385 A1
(43) Pub. Date: Jul. 23, 2020

(54) VIDEO CODING DEVICE, VIDEO DECODING DEVICE, VIDEO CODING METHOD, VIDEO DECODING METHOD AND PROGRAM

(71) Applicant: NEC Corporation, Minato-ku, Tokyo (JP)

(72) Inventor: Keiichi CHONO, Tokyo (JP)

(73) Assignee: NEC Corporation, Minato-ku, Tokyo (JP)

(21) Appl. No.: 16/650,460

(22) PCT Filed: Aug. 31, 2018
(86) PCT No.: PCT/JP2018/032348

§ 371 Date: Mar. 25, 2020

(30) Foreign Application Priority Data
Oct. 3, 2017 (JP) 2017-193502

(51) Int. Cl. H04N 19/513; H04N 19/137; H04N 19/119; H04N 19/176

(52) U.S. Cl. CPC H04N 19/513; H04N 19/176; H04N 19/119; H04N 19/137

(57) ABSTRACT

A video coding device performs video coding using a block based affine transform motion compensated prediction technique that includes a process of calculating a motion vector of each subblock using motion vectors of control points in a block. The video coding device includes block based affine transform motion compensated prediction control means for controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

### TECHNICAL FIELD

The present invention relates to a video coding device and a video decoding device using block based affine transform motion compensated prediction.

### BACKGROUND ART

As a video coding scheme, a scheme based on the HEVC (High Efficiency Video Coding) standard is described in Non Patent Literature (NPL) 1. NPL 2 discloses a block based affine transform motion compensated prediction technique to enhance the compression efficiency of HEVC.

With affine transform motion compensated prediction, motion that involves deformation such as zoom or rotation, which cannot be expressed with motion compensated prediction based on a translation model used in HEVC, can be expressed.

An affine transform motion compensated prediction technique is described in NPL 3.

The foregoing block based affine transform motion compensated prediction (hereafter referred to as “typical block based affine transform motion compensated prediction”) is simplified affine transform motion compensated prediction having the following features.
The top left position and the top right position of a block to be processed are used as control points.
As a motion vector field of the block to be processed, motion vectors of subblocks obtained by dividing the block to be processed in a fixed size are derived.

The typical block based affine transform motion compensated prediction will be described below, with reference to explanatory diagrams in FIGS. 22 and 23. FIG. 22 is an explanatory diagram depicting an example of the positional relationships among a reference picture, a picture to be processed, and a block to be processed. In FIG. 22, picWidth denotes the number of pixels in the horizontal direction, and picHeight denotes the number of pixels in the vertical direction.

FIG. 23 is an explanatory diagram depicting a state in which a unidirectional motion vector is set in each control point (the circles in (B) in FIG. 23) of the block to be processed depicted in FIG. 22 (see (A) in FIG. 23), and a motion vector of each subblock is derived as a motion vector field of the block to be processed (see (C) in FIG. 23).

FIG. 23 depicts an example in which the number of horizontal pixels of the block to be processed is w=16, the number of vertical pixels of the block to be processed is h=16, the prediction direction of the motion vector of the control point is dir=L0, and the number of horizontal pixels and the number of vertical pixels of each subblock are s=4, for the sake of simplicity.

A control point motion vector setting unit 5051 and a subblock motion vector derivation unit 5052 depicted in FIG. 23 are included in a functional block for performing motion compensated prediction in a video coding device.

The control point motion vector setting unit 5051 sets input two motion vectors as motion vectors (v_{TL} and v_{TR} in (B) in FIG. 23) of the top left and top right control points.

A motion vector at a position (x, y) {0≤x≤w−1, 0≤y≤h−1} in the block to be processed is expressed as follows.

v(x)=((v_{TR}(x)−v_{TL}(x))×x/w)−((v_{TR}(y)−v_{TL}(y))×y/w)+v_{TL}(x) (1).

v(y)=((v_{TR}(y)−v_{TL}(y))×x/w)+((v_{TR}(x)−v_{TL}(x))×y/w)+v_{TL}(y) (2).

In the formulas, v_{TL}(x), v_{TL}(y), v_{TR}(x), and v_{TR}(y) respectively denote a component of v_{TL} in the x direction (horizontal direction), a component of v_{TL} in the y direction (vertical direction), a component of v_{TR} in the x direction (horizontal direction), and a component of v_{TR} in the y direction (vertical direction).

Next, the subblock motion vector derivation unit 5052 calculates, for each subblock, a motion vector at the center position in the subblock as a subblock motion vector, based on motion vector expression of the position in the block to be processed.

Thus, the control point motion vector setting unit 5051 and the subblock motion vector derivation unit 5052 determine the subblock motion vectors.

### CITATION LIST

### Non Patent Literatures

NPL 1: R. Joshi et al., “HEVC Screen Content Coding Draft Text 5” document JCTVC-vtr005, Joint Collaborative Team on Video Coding (JCT-VC) of ITU-T SG 16 WP 3 and ISO/IEC JTC1/SC 29/WG 11, 22nd Meeting: Geneva, CH, 15-21 Oct. 2015.
NPL 2: J. Chen et al., “Algorithm Description of Joint Exploration Test Model 5 (JEM 5)” document JVET-E1001-v2, Joint Video Exploration Team (JVET) of ITU-T SG 16 WP 3 and ISO/IEC JTC 1/SC 29/WG 11, 5th Meeting: Geneva, CH, 12-20 Jan. 2017.
NPL 3: K. Zhang et al., “Video coding using affine motion compensated prediction”, ISCASSP 1996.

### SUMMARY OF INVENTION

### Technical Problem

With the typical block based affine transform motion compensated prediction described above, the motion vectors are scattered in the block to be processed. Consequently, in a video coding device using the typical block based affine transform motion compensated prediction, the amount of memory access relating to reference pictures in a motion compensated prediction process increases massively as compared with the case of using normal motion compensated prediction (motion compensated prediction based on a translation model with which motion vectors are not scattered in a block to be processed).

For example, when the typical block based affine transform motion compensated prediction is applied to a video signal of a large image size such as 8K, there is a possibility that the amount of memory access relating to reference pictures exceeds the peak band of memory included in the device.

Herein, the “large image size” means that at least one of the number of pixels picWidth in the horizontal direction of the picture in depicted in FIG. 22 and the number of pixels picHeight in the vertical direction of the picture or the product of picWidth and picHeight (i.e. the area of the picture) is a large value.

As described above, the typical block based affine transform motion compensated prediction has a problem in that the implementation cost of the video coding device and the video decoding device increases.

The present invention has an object of providing a video coding device, a video decoding device, a video coding method, a video decoding method, and a program that can reduce the amount of memory access and reduce the implementation cost in the case of using block based affine transform motion compensated prediction.

### Solution to Problem

A video coding device according to the present invention is a video coding device that performs video coding using a block based affine transform motion compensated prediction technique that includes a process of calculating a motion vector of each subblock using motion vectors of control points in a block, the video coding device including block based affine transform motion compensated prediction control means for controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

A video decoding device according to the present invention is a video decoding device that performs video decoding using a block based affine transform motion compensated prediction technique that includes a process of calculating a motion vector of each subblock using motion vectors of control points in a block, the video decoding device including block based affine transform motion compensated prediction control means for controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

A video coding method according to the present invention is a video coding method of performing video coding using a block based affine transform motion compensated prediction technique that includes a process of calculating a motion vector of each subblock using motion vectors of control points in a block, the video coding method including controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

A video decoding method according to the present invention is a video decoding method of performing video decoding using a block based affine transform motion compensated prediction technique that includes a process of calculating a motion vector of each subblock using motion vectors of control points in a block, the video decoding method including controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

A video coding program according to the present invention is a video coding program executed in a video coding device that performs video coding using a block based affine transform motion compensated prediction technique that includes a process of calculating a motion vector of each subblock using motion vectors of control points in a block, the video coding program causing a computer to control at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

A video decoding program according to the present invention is a video decoding program executed in a video decoding device that performs video decoding using a block based affine transform motion compensated prediction technique that includes a process of calculating a motion vector of each subblock using motion vectors of control points in a block, the video decoding program causing a computer to control at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

### Advantageous Effects of Invention

According to the present invention, the amount of memory access can be reduced, and the implementation cost can be reduced.

Moreover, as a result of the video coding device and the video decoding device reducing the amount of memory access by a common method, high interconnectivity between the video coding device and the video decoding device is ensured.

### BRIEF DESCRIPTION OF DRAWINGS

FIG. 1 is an explanatory diagram depicting an example of 33 types of angular intra prediction.

FIG. 2 is an explanatory diagram depicting an example of inter-frame prediction.

FIG. 3 is an explanatory diagram depicting an example of CTU partitioning of a frame t and an example of CU partitioning of CTU8 of the frame t.

FIG. 4 is an explanatory diagram depicting a quadtree structure corresponding to the example of CU partitioning of CTU8.

FIG. 5 is a block diagram depicting a structure of an exemplary embodiment of a video coding device.

FIG. 6 is a block diagram depicting an example of a structure of a block based affine transform motion compensated prediction controller.

FIG. 7 is an explanatory diagram depicting a state in which a unidirectional motion vector is set in each control point of a block to be processed and a motion vector of each subblock is derived as a motion vector field of the block to be processed in Exemplary Embodiment 1.

FIG. 8 is a flowchart depicting operation of a block based affine transform motion compensated prediction controller in Exemplary Embodiment 1.

FIG. 9 is a block diagram depicting a structure of an exemplary embodiment of a video decoding device.

FIG. 10 is an explanatory diagram depicting a state in which a unidirectional motion vector is set in each control point of a block to be processed and a motion vector of each subblock is derived as a motion vector field of the block to be processed in Exemplary Embodiment 3.

FIG. 11 is a flowchart depicting operation of a block based affine transform motion compensated prediction controller in Exemplary Embodiment 3.

FIG. 12 is an explanatory diagram depicting an example of the positional relationships among a reference picture, a picture to be processed, and a block to be processed in bidirectional prediction.

FIG. 13 is an explanatory diagram depicting a state in which a typical block based affine transform motion compensated prediction controller sets motion vectors of respective directions in each control point of a block to be processed and derives a motion vector of each subblock as a motion vector field of the block to be processed.

FIG. 14 is an explanatory diagram depicting a state in which motion vectors of respective directions are set in each control point of a block to be processed and a motion vector of each subblock is derived as a motion vector field of the block to be processed in Exemplary Embodiment 4.

FIG. 15 is a flowchart depicting operation of a block based affine transform motion compensated prediction controller in Exemplary Embodiment 4.

FIG. 16 is a flowchart depicting operation of a block based affine transform motion compensated prediction controller in Exemplary Embodiment 7.

FIG. 17 is a flowchart depicting operation of a block based affine transform motion compensated prediction controller in Exemplary Embodiment 8.

FIG. 18 is a flowchart depicting operation of a block based affine transform motion compensated prediction controller in Exemplary Embodiment 9.

FIG. 19 is a block diagram depicting an example of a structure of an information processing system capable of realizing functions of a video coding device and a video decoding device.

FIG. 20 is a block diagram depicting main parts of a video coding device.

FIG. 21 is a block diagram depicting main parts of a video decoding device.

FIG. 22 is an explanatory diagram depicting an example of the positional relationships among a reference picture, a picture to be processed, and a block to be processed.

FIG. 23 is an explanatory diagram depicting a state in which a unidirectional motion vector is set in each control point of a block to be processed and a motion vector of each subblock is derived as a motion vector field of the block to be processed.

### DESCRIPTION OF EMBODIMENT

### Exemplary Embodiment 1

First, intra prediction, inter-frame prediction, and signaling of CU and CTU used in a video coding device according to this exemplary embodiment and the below-described video decoding device will be described below.

Each frame of digitized video is split into coding tree units (CTUs), and each CTU is coded in raster scan order.

Each CTU is split into coding units (CUs) and coded, in a quadtree structure. Each CU is prediction-coded. Prediction coding includes intra prediction and inter-frame prediction.

A prediction error of each CU is transform-coded based on frequency transform.

A CU of the largest size is referred to as a “largest CU” (largest coding unit: LCU), and a CU of the smallest size is referred to as a “smallest CU” (smallest coding unit: SCU). The LCU size and the CTU size are the same.

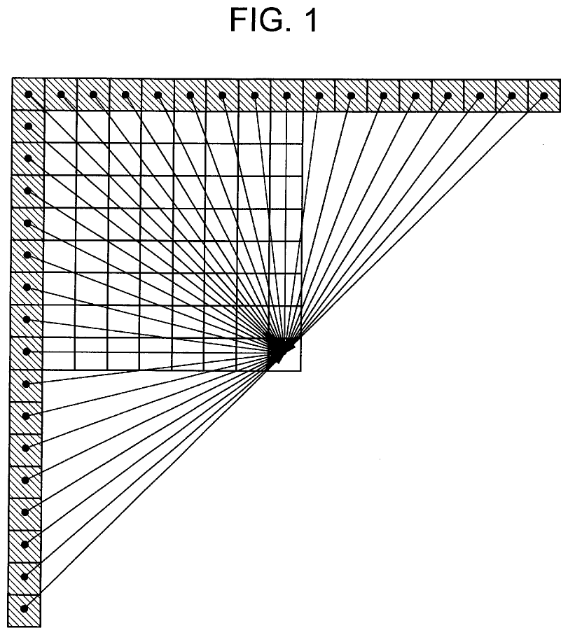

Intra prediction is prediction for generating a prediction image from a reconstructed image having the same display time as a frame to be coded. NPL 1 defines 33 types of angular intra prediction depicted in FIG. 1. In angular intra prediction, a reconstructed pixel near a block to be coded is used for extrapolation in any of 33 directions, to generate an intra prediction signal. In addition to 33 types of angular intra prediction, NPL 1 defines DC intra prediction for averaging reconstructed pixels near the block to be coded, and planar intra prediction for linear interpolating reconstructed pixels near the block to be coded. A CU coded based on intra prediction is hereafter referred to as “intra CU”.

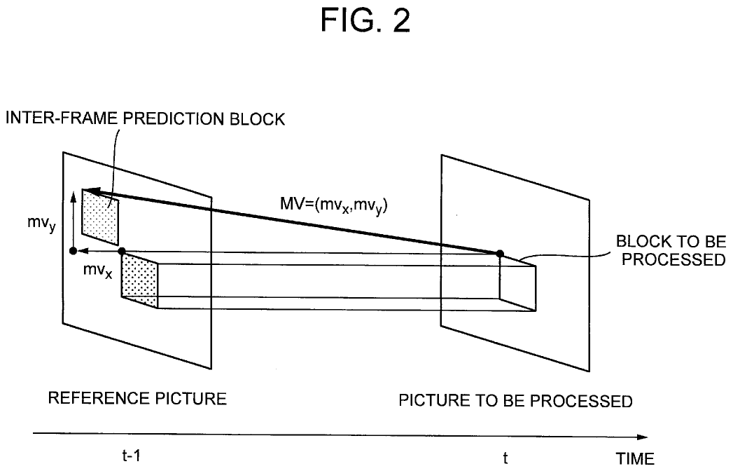

Inter-frame prediction is prediction for generating a prediction image from a reconstructed image (reference picture) different in display time from a frame to be coded. Inter-frame prediction is hereafter also referred to as “inter prediction”. FIG. 2 is an explanatory diagram depicting an example of inter-frame prediction. A motion vector MV=(mvₓ, mv_{y}) indicates the amount of translation of a reconstructed image block of a reference picture relative to a block to be coded. In inter prediction, an inter prediction signal is generated based on a reconstructed image block of a reference picture (using pixel interpolation if necessary). A CU coded based on inter-frame prediction is hereafter referred to as “inter CU”.

In this exemplary embodiment, the video coding device can use the normal motion compensated prediction depicted in FIG. 2 and the foregoing block based affine transform motion compensated prediction, as inter-frame prediction. Whether the normal motion compensated prediction or the block based affine transform motion compensated prediction is used is signaled by inter_affine_flag syntax indicating whether an inter CU is based on block based affine transform motion compensated prediction.

A frame coded including only intra CUs is called “I frame” (or “I picture”). A frame coded including not only intra CUs but also inter CUs is called “P frame” (or “P picture”). A frame coded including inter CUs that each use not only one reference picture but two reference pictures simultaneously for the inter prediction of the block is called “B frame” (or “B picture”).

Inter-frame prediction using one reference picture is referred to as “unidirectional prediction”, and inter-frame prediction using two reference pictures simultaneously is referred to as “bidirectional prediction”.

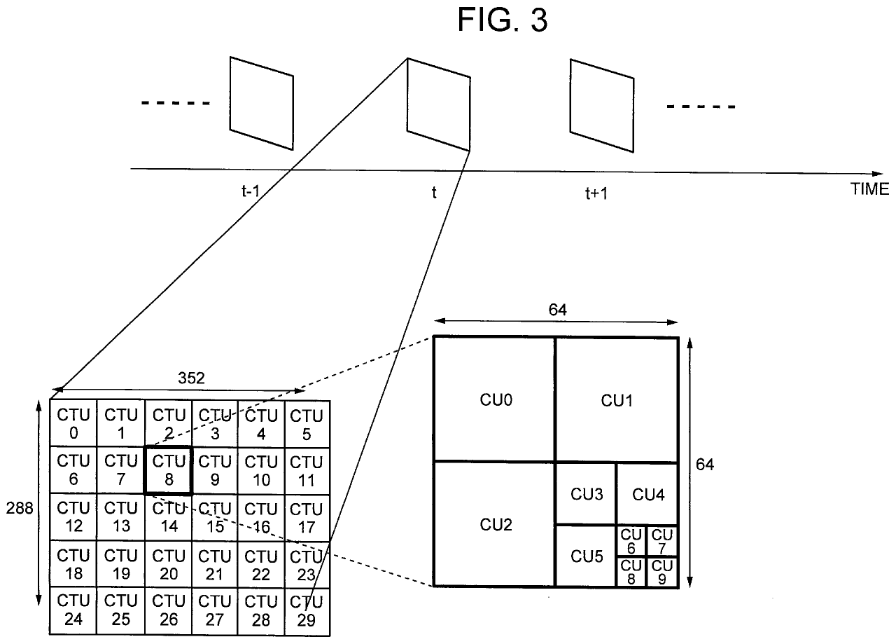

FIG. 3 is an explanatory diagram depicting an example of CTU partitioning of a frame t and an example of CU partitioning of the eighth CTU (CTU8) included in the frame t, in the case where the spatial resolution of the frame is the common intermediate format (CIF) and the CTU size is 64.

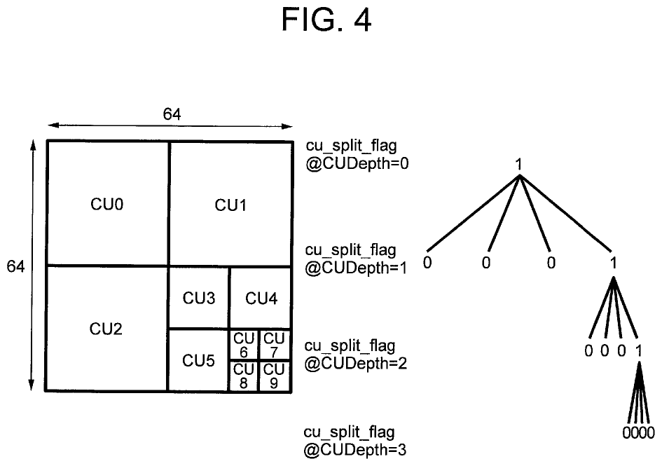

FIG. 4 is an explanatory diagram depicting a quadtree structure corresponding to the example of CU partitioning of CTU8. The quadtree structure, i.e. the CU partitioning shape, of each CTU is signaled by cu_split_flag (referred to as split_cu_flag in NPL 1) syntax described in NPL 1.

This completes the description of intra prediction, inter-frame prediction, and signaling of CTU and CU.

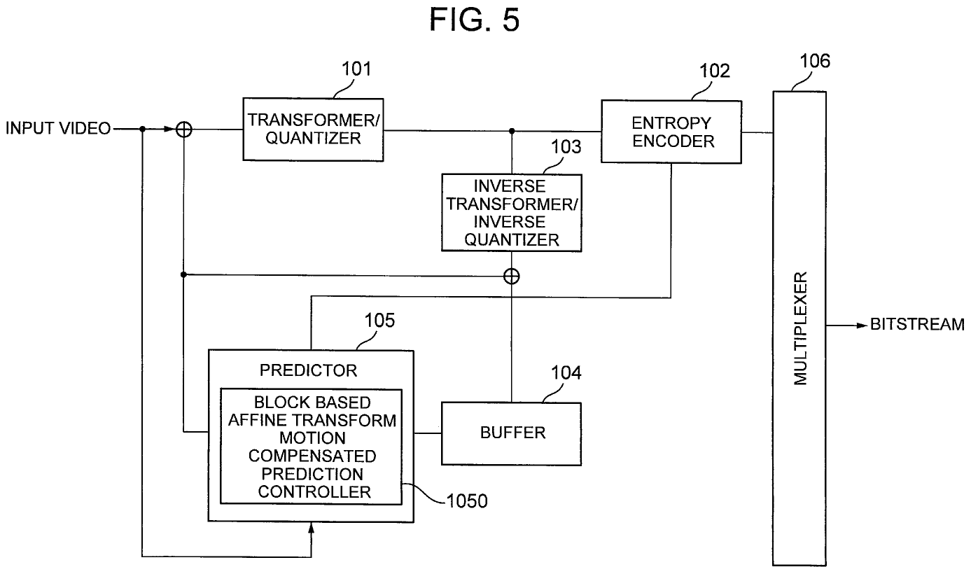

A structure and operation of the video coding device according to this exemplary embodiment that receives each CU of each frame of digitized video as an input image and outputs a bitstream will be described below, with reference to FIG. 5. FIG. 5 is a block diagram depicting an exemplary embodiment of the video coding device.

A video coding device depicted in FIG. 5 includes a transformer/quantizer 101, an entropy encoder 102, an inverse quantizer/inverse transformer 103, a buffer 104, a predictor 105, and a multiplexer 106.

The predictor 105 determines, for each CTU, a cu_split_flag syntax value for determining a CU partitioning shape that minimizes the coding cost.

The predictor 105 then determines, for each CU, a pred_mode_flag syntax value for determining intra prediction/inter prediction, an inter_affine_flag syntax value indicating whether the inter CU is based on block based affine transform motion compensated prediction, an intra prediction direction (intra prediction direction of motion compensated prediction for the block to be processed), and a motion vector that minimize the coding cost. The predictor 105 includes a block based affine transform motion compensated prediction controller 1050. The prediction direction of motion compensated prediction for the block to be processed is hereafter simply referred to as a “prediction direction”.

The predictor 105 generates a prediction signal corresponding to the input image signal of each CU, based on the determined cu_split_flag syntax value, pred_mode_flag syntax value, inter_affine_flag syntax value, intra prediction direction, motion vector, etc. The prediction signal is generated based on the foregoing intra prediction or inter-frame prediction.

Inter-frame prediction is normal motion compensated prediction when inter_affine_flag=0, and is block based affine transform motion compensated prediction otherwise (i.e. when inter_affine_flag=1).

The transformer/quantizer 101 frequency-transforms a prediction error image obtained by subtracting the prediction signal from the input image signal.

The transformer/quantizer 101 further quantizes the frequency-transformed prediction error image (frequency transform coefficient). The quantized frequency transform coefficient is hereafter referred to as a “transform quantization value”.

The entropy encoder 102 entropy-codes the cu_split_flag syntax value, the pred_mode_flag syntax value, the inter_affine_flag syntax value, the difference information of the intra prediction direction, and the difference information of motion vectors determined by the predictor 105, and the transform quantization value.

The inverse quantizer/inverse transformer 103 inverse-quantizes the transform quantization value. The inverse quantizer/inverse transformer 103 further inverse-frequency-transforms the frequency transform coefficient obtained by the inverse quantization. The prediction signal is added to the reconstructed prediction error image obtained by the inverse frequency transform, and the result is supplied to the buffer 104. The buffer 104 stores the reconstructed image.

The multiplexer 106 multiplexes and outputs the entropy-coded data supplied from the entropy encoder 102, as a bitstream.

The bitstream includes the image size, the prediction direction determined by the predictor 105, and the difference between motion vectors determined by the predictor 105 (in particular, the difference between motion vectors of control points in the block).

Operation of the block based affine transform motion compensated prediction controller 1050 will be described below.

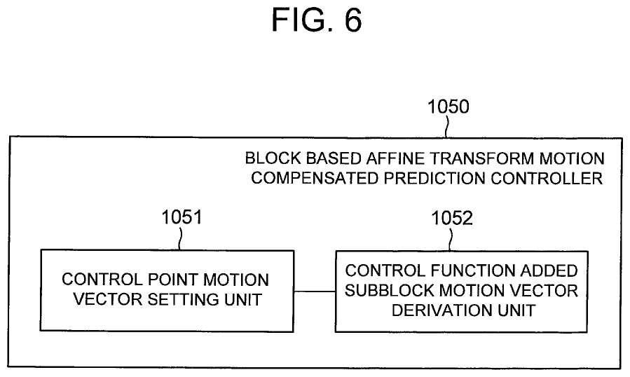

FIG. 6 is a block diagram depicting an example of a structure of the block based affine transform motion compensated prediction controller 1050. In the example depicted in FIG. 6, the block based affine transform motion compensated prediction controller 1050 includes a control point motion vector setting unit 1051 and a control function added subblock motion vector derivation unit 1052.

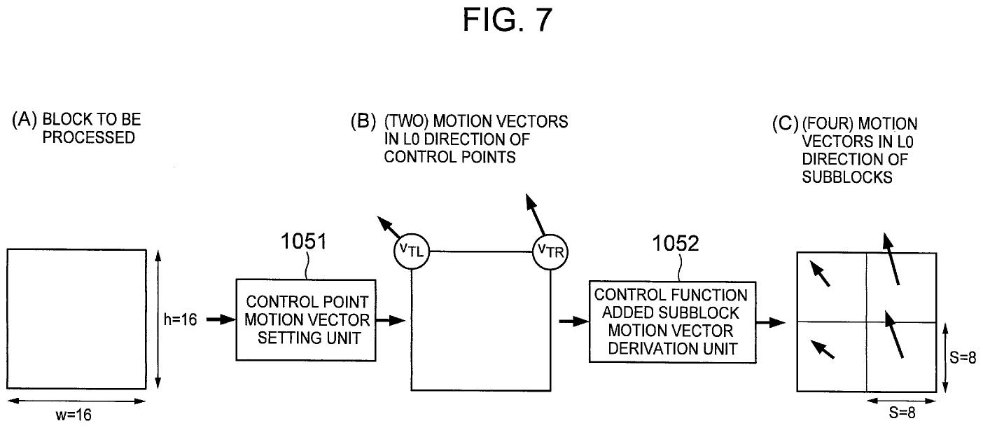

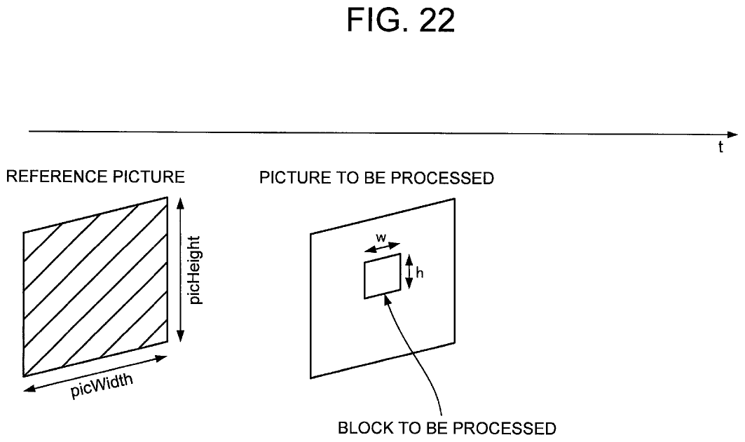

FIG. 7 is an explanatory diagram depicting a state in which a unidirectional motion vector is set in each control point (the circles in (B) in FIG. 7) of the block to be processed depicted in FIG. 22 (see (A) in FIG. 7), and a motion vector of each subblock is derived as a motion vector field of the block to be processed (see (C) in FIG. 7).

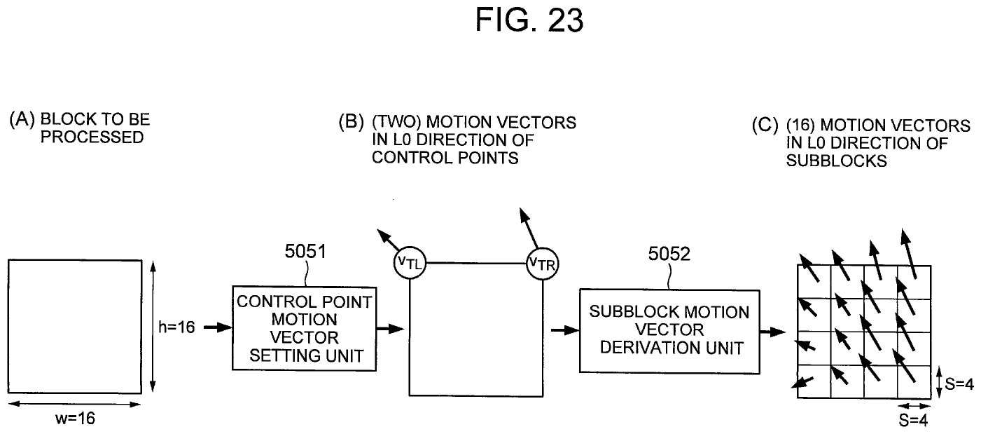

The control point motion vector setting unit 1051 sets input two motion vectors as motion vectors (v_{TL} and v_{TR} in (B) in FIG. 7) of the top left and top right control points, as in the control point motion vector setting unit 5051 in FIG. 23.

A motion vector at a position (x, y) {0≤x≤w−1, 0≤y≤h−1} in the block to be processed is expressed by the foregoing formulas (1) and (2).

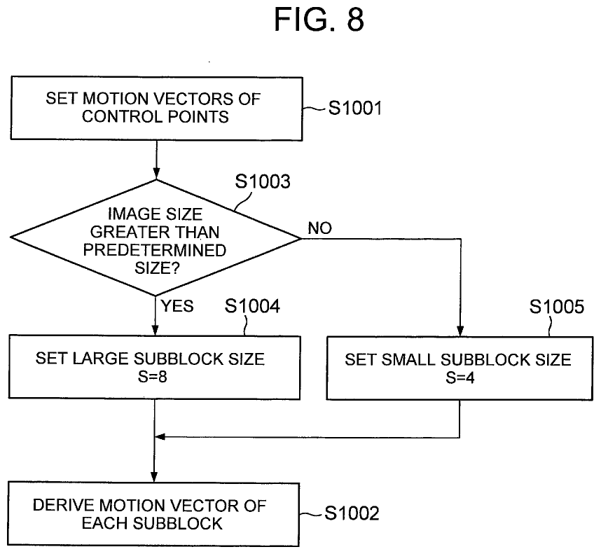

The operation of the block based affine transform motion compensated prediction controller 1050 will be described below, with reference to a flowchart in FIG. 8.

The control point motion vector setting unit 1051 assigns externally input motion vectors to control points of a block to be processed, as in the control point motion vector setting unit 5051 in FIG. 23 (step S1001). The control function added subblock motion vector derivation unit 1052 determines whether the image size is greater than a predetermined size (step S1003). The predetermined size is, for example, 4K size (picWidth=4096 (or 3840), picHeight=2160) or 8K size (picWidth=7680, picHeight=4320), and may be set by a user as appropriate depending on the performance of the video coding device and the like.

In the case where the image size is greater than the predetermined size, the control function added subblock motion vector derivation unit 1052 sets 8×8 pixels which are larger than 4×4 pixel size depicted in FIG. 23, as the subblock size. That is, the control function added subblock motion vector derivation unit 1052 sets S=8 (step S1004).

In the case where the image size is not greater than the predetermined size, the control function added subblock motion vector derivation unit 1052 sets the subblock size to be the same as 4×4 pixel size depicted in FIG. 23. That is, the control function added subblock motion vector derivation unit 1052 sets S=4 (step S1005).

The control function added subblock motion vector derivation unit 1052 calculates, for each subblock, a motion vector at the center position in the subblock based on motion vector representation of position in the block to be processed, and sets the calculated motion vector as a subblock motion vector, as in the subblock motion vector derivation unit 5052 in FIG. 23 (step S1002).

The predictor 105 generates a prediction signal for an input image signal of each CU based on the determined motion vector and the like, as described above.

In the case where the image size is greater than the predetermined size, the number of motion vectors of block based affine transform motion compensated prediction for a block to be processed in the video coding device according to this exemplary embodiment is less than the number of motion vectors in a conventional video coding device, as can be understood from the difference between the number of motion vectors in L0 direction of subblocks in (C) in FIG. 23 and the number of motion vectors in L0 direction of subblocks in (C) in FIG. 7. In the example in FIG. 7, the number of motion vectors is reduced to ¼. The video coding device according to this exemplary embodiment can therefore reduce the amount of memory access relating to reference pictures as compared with a video coding device using a conventional block based affine transform motion compensated prediction controller, in the case where the image size subjected to coding is greater than the predetermined size.

### Exemplary Embodiment 2

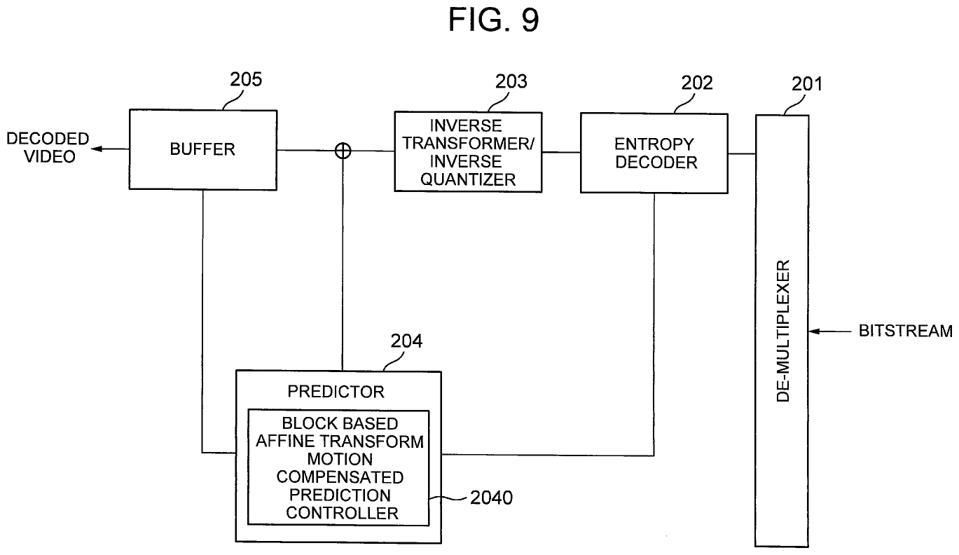

A structure and operation of a video decoding device that receives a bitstream as input from a video coding device or the like and outputs a decoded video frame will be described below, with reference to FIG. 9. The video decoding device according to this exemplary embodiment corresponds to the video coding device according to Exemplary Embodiment 1. That is, the video decoding device according to this exemplary embodiment performs control for memory access amount reduction by the method common with the video coding device according to Exemplary Embodiment 1.

The video decoding device according to this exemplary embodiment includes a de-multiplexer 201, an entropy decoder 202, an inverse quantizer/inverse transformer 203, a predictor 204, and a buffer 205.

The de-multiplexer 201 de-multiplexes an input bitstream to extract an entropy-coded video bitstream.

The entropy decoder 202 entropy-decodes the video bitstream. The entropy decoder 202 entropy-decodes the coding parameters and the transform quantization value, and supplies them to the inverse quantizer/inverse transformer 203 and the predictor 204.

The entropy decoder 202 also supplies cu_split_flag, pred_mode_flag, inter_affine_flag, intra prediction direction, and motion vector to the predictor 204.

The inverse quantizer/inverse transformer 203 inverse-quantizes the transform quantization value. The inverse quantizer/inverse transformer 203 further inverse-frequency-transforms the frequency transform coefficient obtained by the inverse quantization.

After the inverse frequency transform, the predictor 204 generates a prediction signal using a reconstructed image stored in the buffer 205, based on the entropy-decoded cu_split_flag, pred_mode_flag, inter_affine_flag, intra prediction direction, and motion vector. The prediction signal is generated based on the foregoing intra prediction or inter-frame prediction.

Inter-frame prediction is normal motion compensated prediction when inter_affine_flag=0, and is block based affine transform motion compensated prediction otherwise (i.e. when inter_affine_flag=1).

The predictor 204 includes a block based affine transform motion compensated prediction controller 2040. The block based affine transform motion compensated prediction controller 2040 sets a motion vector in each control point and then determines a subblock size depending on whether the image size is greater than the predetermined size, as in the block based affine transform motion compensated prediction controller 1050 in the video coding device according to Exemplary Embodiment 1. The block based affine transform motion compensated prediction controller 2040 then calculates, for each subblock, a motion vector at the center position in the subblock based on motion vector representation of position in the block to be processed, and sets the calculated motion vector as a subblock motion vector. In detail, the block based affine transform motion compensated prediction controller 2040 includes blocks that operate in the same way as the control point motion vector setting unit 1051 and the control function added subblock motion vector derivation unit 1052.

After the prediction signal is generated, the prediction signal supplied from the predictor 204 is added to the reconstructed prediction error image obtained by the inverse frequency transform by the inverse quantizer/inverse transformer 203, and the result is supplied to the buffer 205 as a reconstructed image.

The reconstructed image stored in the buffer 205 is then output as a decoded image (decoded video).

In the case where the image size is greater than the predetermined size, the number of motion vectors of block based affine transform motion compensated prediction for a block to be processed in the video decoding device according to this exemplary embodiment is less than the number of motion vectors in a conventional video decoding device, as can be understood from the difference between the number of motion vectors in L0 direction of subblocks in (C) in FIG. 23 and the number of motion vectors in L0 direction of subblocks in (C) in FIG. 7. In the example in FIG. 7, the number of motion vectors is reduced to ¼. The video decoding device according to this exemplary embodiment can therefore reduce the amount of memory access relating to reference pictures as compared with a video decoding device using a conventional block based affine transform motion compensated prediction controller, in the case where the image size subjected to decoding is greater than the predetermined size.

### Exemplary Embodiment 3

In the video coding device according to Exemplary Embodiment 1 and the video decoding device according to Exemplary Embodiment 2, the block based affine transform motion compensated prediction controllers 1050 and 2040 increase the subblock size to reduce the amount of memory access, in the case of determining that the amount of memory access relating to reference pictures is large.

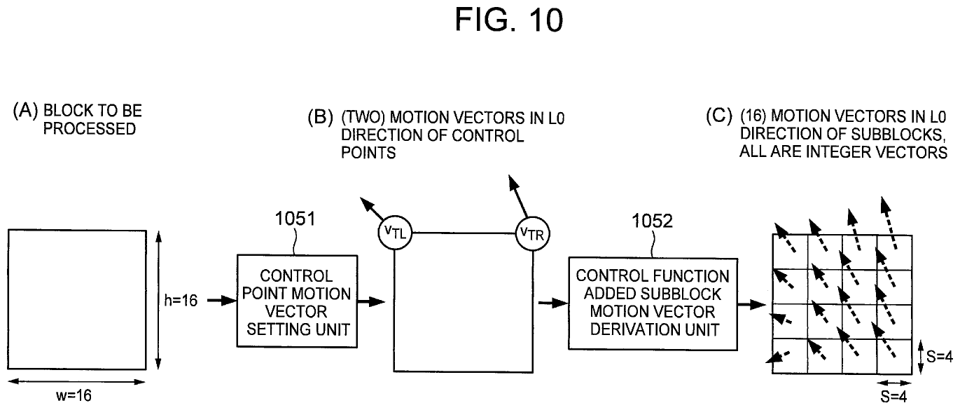

The amount of memory access can also be reduced by making the subblock motion vector into an integer vector (i.e. changing the pixel position designated by the motion vector to an integer position) as depicted in FIG. 10, instead of increasing the subblock size. By changing the pixel position to an integer position, a fractional pixel position interpolation process is omitted, so that the amount of memory access is reduced by the amount corresponding to the interpolation process.

FIG. 10 is an explanatory diagram depicting a state in which a unidirectional motion vector is set in each control point (the circles in (B) in FIG. 10) of the block to be processed depicted in FIG. 22 (see (A) in FIG. 10) and a motion vector of each subblock is derived as a motion vector field of the block to be processed (see (C) in FIG. 10), in a video coding device and a corresponding video decoding device according to Exemplary Embodiment 3.

The video coding device and the corresponding video decoding device according to Exemplary Embodiment 3 may have the same overall structures as those depicted in FIGS. 5 and 9.

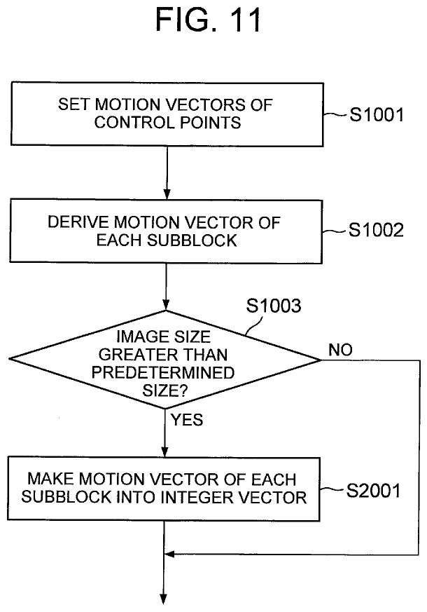

The operation of the block based affine transform motion compensated prediction controller 1050 in the video coding device according to Exemplary Embodiment 3 will be described below, with reference to a flowchart in FIG. 11. The block based affine transform motion compensated prediction controller 2040 in the video decoding device operates in the same way as the block based affine transform motion compensated prediction controller 1050.

The control point motion vector setting unit 1051 assigns externally input motion vectors to control points of a block to be processed, as in the control point motion vector setting unit 5051 in FIG. 23 (step S1001). The control function added subblock motion vector derivation unit 1052 calculates, for each subblock, a motion vector at the center position in the subblock, and sets the calculated motion vector as a subblock motion vector, as in the subblock motion vector derivation unit 5052 in FIG. 23 (step S1002). The motion vector is a vector of fractional precision.

The control function added subblock motion vector derivation unit 1052 then determines whether the image size is greater than a predetermined size (step S1003). In the case where the image size is not greater than the predetermined size, the process ends. In this case, the motion vector v remains to be a vector of fractional precision.

In the case where the image size is greater than the predetermined size, the control function added subblock motion vector derivation unit 1052 rounds the motion vector v of each subblock to a vector of integer precision (step S2001).

The motion vector v is expressed by the following formulas.

v_{INT}(x)=floor(v(x),prec)

v_{INT}(y)=floor(v(x),prec) (3).

In the formulas, floor(a, b) is a function returning a multiple of b. The returned multiple of b is closest to a variable a among plural multiples of b. “prec” means pixel precision of a motion vector. For example, in the case where the motion vector pixel precision is 1/16, prec=16.

The predictor 105 (in the video decoding device, the predictor 204) generates a prediction signal for an input image signal of each CU, based on the determined motion vector and the like.

### Exemplary Embodiment 4

In the video coding device according to Exemplary Embodiment 1 and the video decoding device according to Exemplary Embodiment 2, the block based affine transform motion compensated prediction controllers 1050 and 2040 increase the subblock size to reduce the amount of memory access, in the case of determining that the amount of memory access relating to reference pictures is large.

The amount of memory access can also be reduced by forcedly setting the motion vector of the block to be processed in bidirectional prediction to unidirectional, instead of increasing the subblock size.

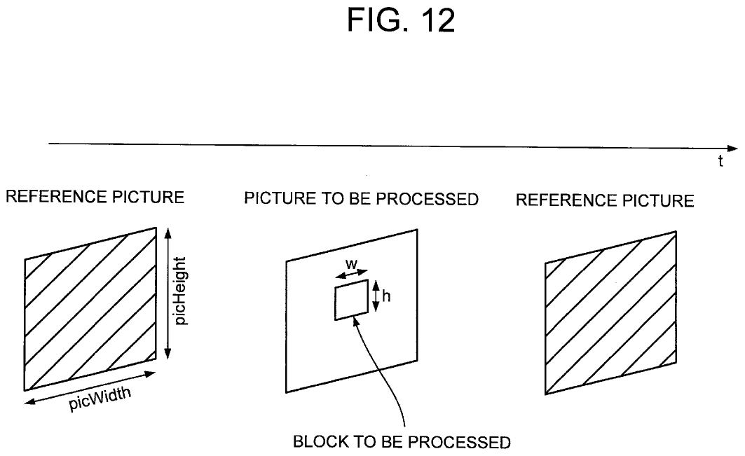

FIG. 12 is an explanatory diagram depicting an example of the positional relationships among a reference picture, a picture to be processed, and a block to be processed in bidirectional prediction.

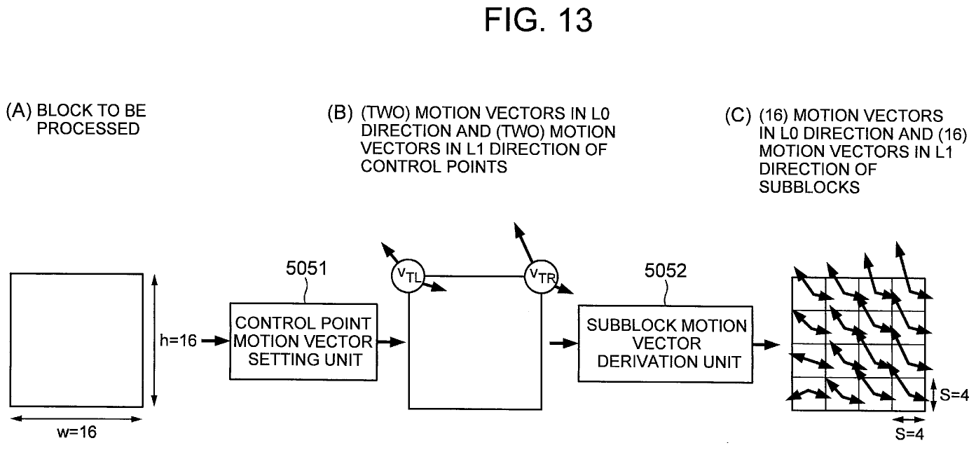

FIG. 13 is an explanatory diagram for comparison between typical block based affine transform motion compensated prediction and Exemplary Embodiment 4. Specifically, FIG. 13 is an explanatory diagram depicting a state in which a typical block based affine transform motion compensated prediction controller (including the control point motion vector setting unit 5051 and the subblock motion vector derivation unit 5052 depicted in FIG. 23) sets motion vectors of respective directions in each control point (the circles in (B) in FIG. 13) of the block to be processed depicted in FIG. 12 (see (A) in FIG. 13), and derives a motion vector of each subblock as a motion vector field of the block to be processed (see (C) in FIG. 13).

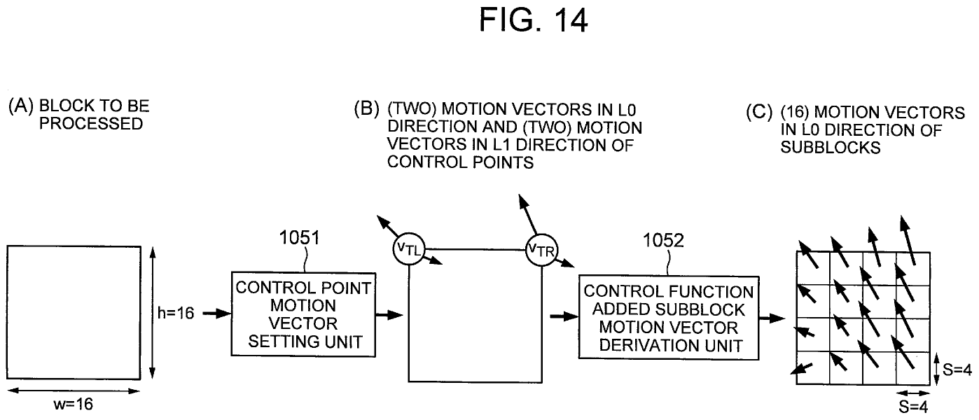

FIG. 14 is an explanatory diagram depicting a state in which the block based affine transform motion compensated prediction controller 1050 in the video coding device according to Exemplary Embodiment 4 sets motion vectors of respective directions in each control point (the circles in (B) in FIG. 14) of the block to be processed depicted in FIG. 12 (see (A) in FIG. 14), and derives a motion vector of each subblock as a motion vector field of the block to be processed (see (C) in FIG. 14).

The video coding device and the corresponding video decoding device according to Exemplary Embodiment 4 may have the same overall structures as those depicted in FIGS. 5 and 9.

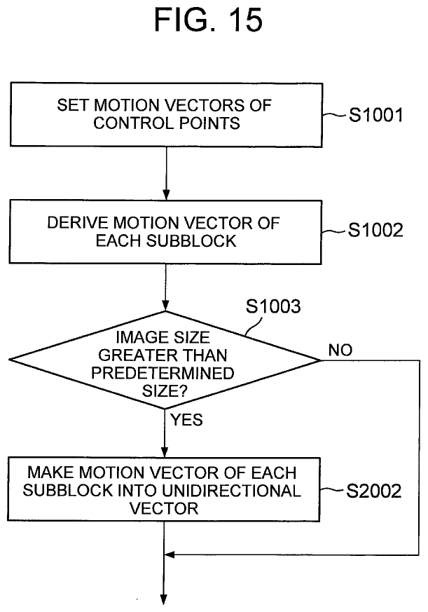

The operation of the block based affine transform motion compensated prediction controller 1050 in the video coding device according to Exemplary Embodiment 4 will be described below, with reference to a flowchart in FIG. 15. The block based affine transform motion compensated prediction controller 2040 in the video decoding device operates in the same way as the block based affine transform motion compensated prediction controller 1050.

The control point motion vector setting unit 1051 assigns externally input motion vectors to control points of a block to be processed, as in the control point motion vector setting unit 5051 in FIG. 23 (step S1001). The control function added subblock motion vector derivation unit 1052 calculates, for each subblock, a motion vector at the center position in the subblock, and sets the calculated motion vector as a subblock motion vector, as in the subblock motion vector derivation unit 5052 in FIG. 23 (step S1002).

The control function added subblock motion vector derivation unit 1052 then determines whether the image size is greater than a predetermined size (step S1003). In the case where the image size is not greater than the predetermined size, the process ends. In this case, the motion vector may be a bidirectional vector.

In the case where the image size is greater than the predetermined size, the control function added subblock motion vector derivation unit 1052 disables the subblock motion vector in L1 direction, to limit the motion vector v of each subblock to unidirectional (step S2002).

The predictor 105 (in the video decoding device, the predictor 204) generates a prediction signal for an input image signal of each CU, based on the determined motion vector and the like.

The control function added subblock motion vector derivation unit 1052 may disable the subblock motion vector in L0 direction, instead of disabling the subblock motion vector in L1 direction. Furthermore, the video coding device may multiplex syntax of information about the prediction direction to be disabled into the bitstream, and the video decoding device may extract the syntax of the information from the bitstream and disable the motion vector in the prediction direction.

The number of motion vectors of block based affine transform motion compensated prediction for a block to be processed in the video coding device and the video decoding device according to this exemplary embodiment is less than the number of motion vectors of block based affine transform motion compensated prediction in a conventional video coding device and video decoding device, as can be understood from the difference between the number of motion vectors of subblocks in (C) in FIG. 13 and the number of motion vectors of subblocks in (C) in FIG. 14 (specifically, ½). The video coding device and the video decoding device according to this exemplary embodiment can therefore reduce the amount of memory access relating to reference pictures as compared with a video coding process and video decoding process using a conventional block based affine transform motion compensated prediction controller, in the case where the image size subjected to coding is greater than the predetermined size.

As is clear from the above description, for all blocks of P pictures not using bidirectional prediction and blocks not using bidirectional prediction (i.e. blocks of unidirectional prediction) in B pictures, the number of motion vectors of block based affine transform motion compensated prediction for a block to be processed in this exemplary embodiment is the same as that in the case of using the typical block based affine transform motion compensated prediction. Accordingly, the block based affine transform motion compensated prediction in this exemplary embodiment may be limited to only blocks using bidirectional prediction.

### Exemplary Embodiment 5

In the video coding device and the video decoding device according to each of the foregoing exemplary embodiments, the block based affine transform motion compensated prediction controllers 1050 and 2040 determine whether the amount of memory access relating to reference pictures is large based on the image size, and, in the case of determining that the amount of memory access relating to reference pictures is large, derive a motion vector of each subblock so as to reduce the amount of memory access.

Instead of determining whether the amount of memory access relating to reference pictures is large based on the image size, the block based affine transform motion compensated prediction controller 1050 may determine whether the amount of memory access relating to reference pictures is large based on the prediction direction of the block to be processed.

Specifically, instead of the determination in step S1003 (see FIGS. 8, 11, and 15), the control function added subblock motion vector derivation unit 1052 determines that the amount of memory access relating to reference pictures is large in the case where the prediction direction of the block to be processed is bidirectional prediction, and does not determine that the amount of memory access relating to reference pictures is large otherwise (i.e. in the case where the prediction direction of the block to be processed is unidirectional prediction).

The block based affine transform motion compensated prediction controller 2040 in the video decoding device operates in the same way as the block based affine transform motion compensated prediction controller 1050.

The video coding device and the corresponding video decoding device according to Exemplary Embodiment 5 may have the same overall structures as those depicted in FIGS. 5 and 9.

### Exemplary Embodiment 6

In the video coding device and the video decoding device according to each of the foregoing exemplary embodiments, the block based affine transform motion compensated prediction controllers 1050 and 2040 determine whether the amount of memory access relating to reference pictures is large based on the image size or the prediction direction, and, in the case of determining that the amount of memory access relating to reference pictures is large, derive a motion vector of each subblock so as to reduce the amount of memory access.

Instead of determining whether the amount of memory access relating to reference pictures is large based on the image size or the prediction direction, the block based affine transform motion compensated prediction controller 1050 may determine whether the amount of memory access relating to reference pictures is large based on the relationship between the motion vector of the top left control point and the motion vector of the top right control point, i.e. v_{TL} and v_{TR}, of the block to be processed.

Specifically, instead of the determination in step S1003 (see FIGS. 8, 11, and 15), the control function added subblock motion vector derivation unit 1052 determines that the amount of memory access relating to reference pictures is large in the case where the difference between v_{TL} and v_{TR} of the block to be processed is greater than a predetermined value, and does not determine that the amount of memory access relating to reference pictures is large otherwise (i.e. in the case where the difference is not greater than the predetermined value).

The block based affine transform motion compensated prediction controller 2040 in the video decoding device operates in the same way as the block based affine transform motion compensated prediction controller 1050.

The video coding device and the corresponding video decoding device according to Exemplary Embodiment 6 may have the same overall structures as those depicted in FIGS. 5 and 9.

### Exemplary Embodiment 7

In the video coding device according to Exemplary Embodiment 1 and the video decoding device according to Exemplary Embodiment 2, the block based affine transform motion compensated prediction controllers 1050 and 2040 determine whether the amount of memory access relating to reference pictures is large based on the image size, and, in the case of determining that the amount of memory access relating to reference pictures is large, increase the subblock size to reduce the amount of memory access.

Instead of performing determination based on the image size, the block based affine transform motion compensated prediction controllers 1050 and 2040 may control the constantly used subblock size S based on syntax. That is, the multiplexer 106 in the video coding device may multiplex log 2_affine_subblock_size_minus2 syntax indicating information about the subblock size S into the bitstream, and the de-multiplexer 201 in the video decoding device may extract the syntax of the information from the bitstream and decode the syntax to obtain the subblock size S, which is then used by the predictor 204.

The relationship between the log 2_affine_subblock_size_minus2 syntax value and the subblock size S is expressed by the following formula.

S=1<<(log 2_affine_subblock_size_minus2+2) (4).

In the formula, << denotes bit shift operation in the left direction.

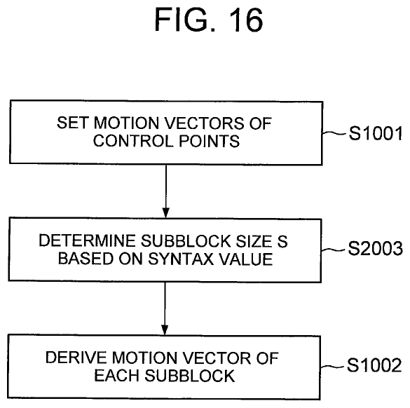

The operation of the block based affine transform motion compensated prediction controller 1050 in the video coding device according to Exemplary Embodiment 7 that performs the above-described control will be described below, with reference to a flowchart in FIG. 16. The block based affine transform motion compensated prediction controller 2040 in the video decoding device operates in the same way as the block based affine transform motion compensated prediction controller 1050.

The control point motion vector setting unit 1051 assigns externally input motion vectors to control points of a block to be processed, as in the control point motion vector setting unit 5051 in FIG. 23 (step S1001).

The control function added subblock motion vector derivation unit 1052 determines the subblock size S from the log 2_affine_subblock_size_minus2 syntax value, based on the relational formula (4) (step S2003).

The control function added subblock motion vector derivation unit 1052 calculates, for each subblock, a motion vector at the center position in the subblock, and sets the calculated motion vector as a subblock motion vector, as in the subblock motion vector derivation unit 5052 in FIG. 23 (step S1002). In this exemplary embodiment, the control function added subblock motion vector derivation unit 1052 calculates the subblock motion vector for the subblock of the subblock size S determined in the process of step S2002.

The predictor 105 (in the video decoding device, the predictor 204) generates a prediction signal for an input image signal of each CU, based on the determined motion vector and the like.

The video coding device and the corresponding video decoding device according to Exemplary Embodiment 7 may have the same overall structures as those depicted in FIGS. 5 and 9.

In this exemplary embodiment, the image size determination process is unnecessary, so that the structure of the block based affine transform motion compensated prediction controllers 1050 and 2040 can be simplified.

### Exemplary Embodiment 8

In the video coding device and the video decoding device according to Exemplary Embodiment 3, the block based affine transform motion compensated prediction controllers 1050 and 2040 determine whether the amount of memory access relating to reference pictures is large based on the image size, and, in the case of determining that the amount of memory access relating to reference pictures is large, make the subblock motion vector into an integer vector to reduce the amount of memory access.

Alternatively, the block based affine transform motion compensated prediction controllers 1050 and 2040 may determine whether to make the subblock motion vector into an integer vector based on syntax indicating whether to make the motion vector into an integer vector.

That is, the multiplexer 106 in the video coding device may multiplex enable_affine_sublock_integer_mv_flag syntax indicating information about whether to apply integer precision (i.e. whether integer precision is enabled) into the bitstream, and the de-multiplexer 201 in the video decoding device may extract the syntax of the information from the bitstream and decode the syntax to obtain the information, which is then used by the predictor 204.

In the case where the enable_affine_sublock_integer_mv_flag syntax value is 1, integer precision is applied (integer precision is enabled). Otherwise (i.e. in the case where the enable_affine_sublock_integer_mv_flag syntax value is 0), integer precision is not applied (integer precision is disabled).

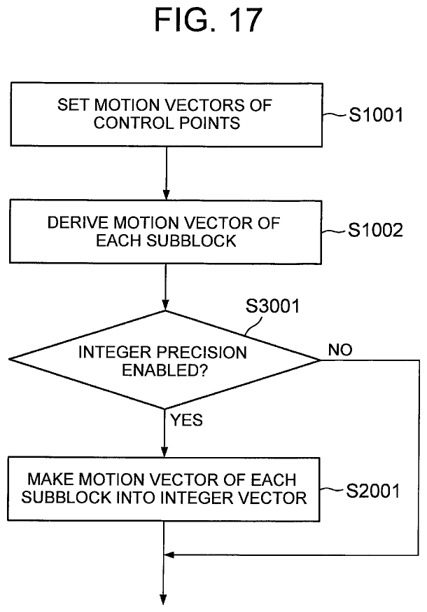

The operation of the block based affine transform motion compensated prediction controller 1050 in the video coding device according to Exemplary Embodiment 8 that performs the above-described control will be described below, with reference to a flowchart in FIG. 17. The block based affine transform motion compensated prediction controller 2040 in the video decoding device operates in the same way as the block based affine transform motion compensated prediction controller 1050.

The control point motion vector setting unit 1051 assigns externally input motion vectors to control points of a block to be processed, as in the control point motion vector setting unit 5051 in FIG. 23 (step S1001).

The control function added subblock motion vector derivation unit 1052 calculates, for each subblock, a motion vector at the center position in the subblock, and sets the calculated motion vector as a subblock motion vector, as in the subblock motion vector derivation unit 5052 in FIG. 23 (step S1002).

The control function added subblock motion vector derivation unit 1052 determines whether to make the subblock motion vector into integer vector (i.e. whether integer precision is enabled), from enable_affine_sublock_integer_mv_flag (step S3001). In the case where integer precision is not enabled, the process ends.

In the case where integer precision is enabled, the control function added subblock motion vector derivation unit 1052 rounds the motion vector v of each subblock to a vector of integer precision (step S2001). The motion vector v of integer precision is expressed by the foregoing formula (3).

The predictor 105 (in the video decoding device, the predictor 204) generates a prediction signal for an input image signal of each CU, based on the determined motion vector and the like.

The video coding device and the corresponding video decoding device according to Exemplary Embodiment 8 may have the same overall structures as those depicted in FIGS. 5 and 9.

### Exemplary Embodiment 9

In the video coding device and the video decoding device according to Exemplary Embodiment 4, the block based affine transform motion compensated prediction controllers 1050 and 2040 determine whether the amount of memory access relating to reference pictures is large based on the image size, and, in the case of determining that the amount of memory access relating to reference pictures is large, forcedly set the motion vector of the block to be processed in bidirectional prediction to be a unidirectional motion vector to reduce the amount of memory access.

Alternatively, the block based affine transform motion compensated prediction controllers 1050 and 2040 may determine whether to forcedly make the motion vector of the block to be processed in bidirectional prediction into a unidirectional motion vector based on syntax indicating whether to make the motion vector to an integer vector.

That is, the multiplexer 106 in the video coding device may multiplex disable_affine_sublock_bipred_mv_flag syntax indicating information about whether to forcedly set the motion vector to unidirectional (i.e. whether change to unidirectional is enabled) into the bitstream, and the de-multiplexer 201 in the video decoding device may extract the syntax of the information from the bitstream and decode the syntax to obtain the information, which is then used by the predictor 204.

In the case where the disable_affine_sublock_bipred_mv_flag syntax value is 1, forced change to unidirectional is not performed (change to unidirectional is disabled). Otherwise (i.e. disable_affine_sublock_bipred_mv_flag syntax value is 0), forced change to unidirectional is performed (change to unidirectional is enabled).

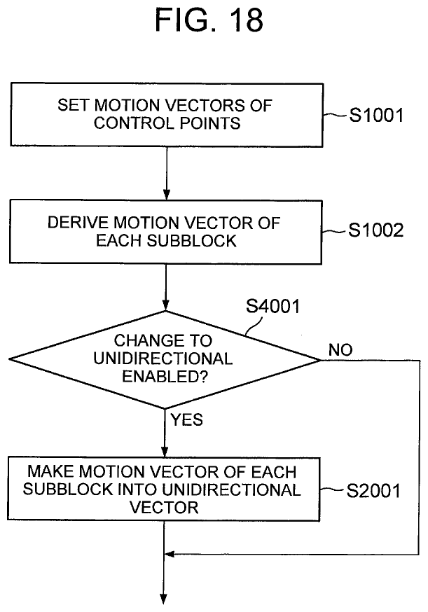

The operation of the block based affine transform motion compensated prediction controller 1050 in the video coding device according to Exemplary Embodiment 9 that performs the above-described control will be described below, with reference to a flowchart in FIG. 18. The block based affine transform motion compensated prediction controller 2040 in the video decoding device operates in the same way as the block based affine transform motion compensated prediction controller 1050.

The control point motion vector setting unit 1051 assigns externally input motion vectors to control points of a block to be processed, as in the control point motion vector setting unit 5051 in FIG. 23 (step S1001).

The control function added subblock motion vector derivation unit 1052 calculates, for each subblock, a motion vector at the center position in the subblock, and sets the calculated motion vector as a subblock motion vector, as in the subblock motion vector derivation unit 5052 in FIG. 23 (step S1002).

The control function added subblock motion vector derivation unit 1052 determines whether to set the subblock motion vector to unidirectional (i.e. whether change to unidirectional is enabled), from disable_affine_sublock_bipred_mv_flag (step S4001). In the case where change to unidirectional is not enabled, the process ends.

In the case where change to unidirectional is enabled, the control function added subblock motion vector derivation unit 1052 disables the subblock motion vector in L1 direction, to limit the motion vector v of each subblock to unidirectional (step S2001).

The predictor 105 (in the video decoding device, the predictor 204) generates a prediction signal for an input image signal of each CU, based on the determined motion vector and the like.

The video coding device and the corresponding video decoding device according to Exemplary Embodiment 9 may have the same overall structures as those depicted in FIGS. 5 and 9.

As in Exemplary Embodiment 4, the control function added subblock motion vector derivation unit 1052 may disable the subblock motion vector in L0 direction, instead of disabling the subblock motion vector in L1 direction. Furthermore, the video coding device may multiplex syntax of information about the prediction direction to be disabled into the bitstream, and the video decoding device may extract the syntax of the information from the bitstream and disable the motion vector in the prediction direction.

As described above, in the block based affine transform motion compensated prediction in each of the foregoing exemplary embodiments, the control function added subblock motion vector derivation unit determines whether the amount of memory access relating to reference pictures is large, and, in the case of determining that the amount of memory access is large, derives the subblock motion vector so as to reduce the amount of memory access relating to reference pictures.

Whether the amount of memory access relating to reference pictures is large is determined using at least one of the image size, the prediction direction (the prediction direction of motion compensated prediction for the block to be processed), and the difference between motion vectors of control points in the block to be processed.

Moreover, the amount of memory access relating to reference pictures is reduced using at least one of limitation of the number of motion vectors and motion vector precision decrease, as follows.

Limitation of the number of motion vectors: increasing the subblock size, setting the prediction direction to unidirectional, or a combination thereof.

Motion vector precision decrease: rounding the motion vector of the subblock to a motion vector of integer precision.

The foregoing exemplary embodiments may be used singly, or two or more exemplary embodiments may be combined as appropriate.

Specifically, although the determination of whether the amount of memory access is large is performed using the image size, the prediction direction of the block to be processed, or the difference between the motion vectors of the control points in the block to be processed in the video coding device and the video decoding device according to each of the foregoing exemplary embodiments, any combination of these three elements may be used in the determination.

Although the reduction of the amount of memory access is performed by increasing the subblock size, making the subblock motion vector into integer vector, or limiting the subblock motion vector to unidirectional in the video coding device and the video decoding device according to each of the foregoing exemplary embodiments, any combination of these three methods may be used.

Each of the foregoing exemplary embodiments may be realized by hardware or a computer program.

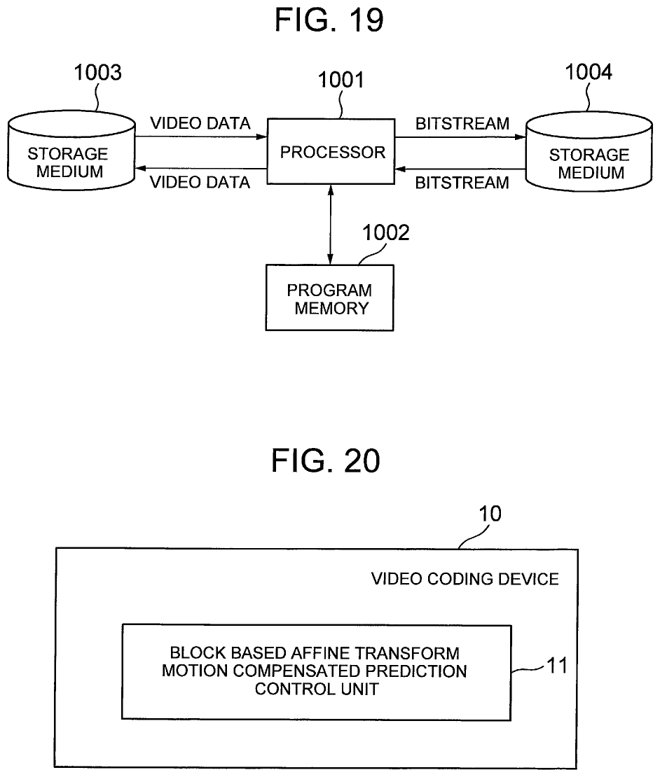

An information processing system depicted in FIG. 19 includes a processor 1001, a program memory 1002, a storage medium 1003 for storing video data, and a storage medium 1004 for storing a bitstream. The storage medium 1003 and the storage medium 1004 may be separate storage media, or storage areas included in the same storage medium. A magnetic storage medium such as a hard disk is available as a storage medium.

In the information processing system depicted in FIG. 19, a program for realizing the functions of the blocks (except the buffer block) depicted in FIG. 5 or the blocks (except the buffer block) depicted in FIG. 9 is stored in the program memory 1002. The processor 1001 realizes the functions of the video coding device or the video decoding device according to the foregoing exemplary embodiments, by executing processes according to the program stored in the program memory 1002.

FIG. 20 is a block diagram depicting main parts of a video coding device. As depicted in FIG. 20, a video coding device 10 includes a block based affine transform motion compensated prediction control unit 11 (corresponding to the block based affine transform motion compensated prediction controller 1050 in the exemplary embodiments) for controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

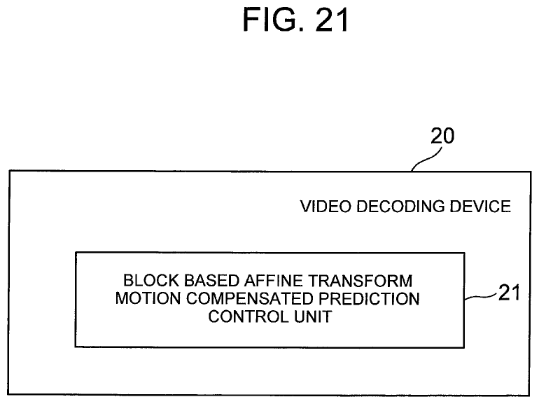

FIG. 21 is a block diagram depicting main parts of a video decoding device. As depicted in FIG. 21, a video decoding device 20 includes a block based affine transform motion compensated prediction control unit 21 (corresponding to the block based affine transform motion compensated prediction controller 2040 in the exemplary embodiments) for controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

All or part of the foregoing exemplary embodiments can be described as the following supplementary notes, although the present invention is not limited to the following structures.

(Supplementary note 1) A video coding device that performs video coding using a block based affine transform motion compensated prediction technique that includes a process of calculating a motion vector of each subblock using motion vectors of control points in a block, the video coding device including block based affine transform motion compensated prediction control means for controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

(Supplementary note 2) The video coding device according to supplementary note 1, wherein the block based affine transform motion compensated prediction control means: increases the block size of the subblock in the case of controlling the block size of the subblock; limits the prediction direction to unidirectional in the case of controlling the prediction direction; and rounds the motion vector of the subblock to a motion vector of integer precision in the case of controlling the motion vector precision.

(Supplementary note 3) A video decoding device that performs video decoding using a block based affine transform motion compensated prediction technique that includes a process of calculating a motion vector of each subblock using motion vectors of control points in a block, the video decoding device including block based affine transform motion compensated prediction control means for controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

(Supplementary note 4) The video decoding device according to supplementary note 3, wherein the block based affine transform motion compensated prediction control means: increases the block size of the subblock in the case of controlling the block size of the subblock; limits the prediction direction to unidirectional in the case of controlling the prediction direction; and rounds the motion vector of the subblock to a motion vector of integer precision in the case of controlling the motion vector precision.

(Supplementary note 5) A video coding method of performing video coding using a block based affine transform motion compensated prediction technique that includes a process of calculating a motion vector of each subblock using motion vectors of control points in a block, the video coding method including controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

(Supplementary note 6) The video coding method according to supplementary note 5, wherein: the block size of the subblock is increased in the case of controlling the block size of the subblock; the prediction direction is limited to unidirectional in the case of controlling the prediction direction; and the motion vector of the subblock is rounded to a motion vector of integer precision in the case of controlling the motion vector precision.

(Supplementary note 7) A video decoding method of performing video decoding using a block based affine transform motion compensated prediction technique that includes a process of calculating a motion vector of each subblock using motion vectors of control points in a block, the video decoding method including controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

(Supplementary note 8) The video decoding method according to supplementary note 7, wherein: the block size of the subblock is increased in the case of controlling the block size of the subblock; the prediction direction is limited to unidirectional in the case of controlling the prediction direction; and the motion vector of the subblock is rounded to a motion vector of integer precision in the case of controlling the motion vector precision.

(Supplementary note 9) A video coding program executed in a video coding device that performs video coding using a block based affine transform motion compensated prediction technique that includes a process of calculating a motion vector of each subblock using motion vectors of control points in a block, the video coding program causing a computer to control at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

(Supplementary note 10) The video coding program according to supplementary note 9, wherein the computer is caused to perform a process for: increasing the block size of the subblock in the case of controlling the block size of the subblock; limiting the prediction direction to unidirectional in the case of controlling the prediction direction; and rounding the motion vector of the subblock to a motion vector of integer precision in the case of controlling the motion vector precision.

(Supplementary note 11) A video decoding program executed in a video decoding device that performs video decoding using a block based affine transform motion compensated prediction technique that includes a process of calculating a motion vector of each subblock using motion vectors of control points in a block, the video decoding program causing a computer to control at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

(Supplementary note 12) The video decoding program according to supplementary note 11, wherein the computer is caused to perform a process for: increasing the block size of the subblock in the case of controlling the block size of the subblock; limiting the prediction direction to unidirectional in the case of controlling the prediction direction; and rounding the motion vector of the subblock to a motion vector of integer precision in the case of controlling the motion vector precision.

(Supplementary note 13) A video coding program for implementing the video coding method according to supplementary note 5 or 6.

(Supplementary note 14) A video decoding program for implementing the video decoding method according to supplementary note 7 or 8.

This application claims priority based on Japanese Patent Application No. 2017-193502 filed on Oct. 3, 2017, the disclosure of which is incorporated herein in its entirety.

Although the present invention has been described with reference to the foregoing exemplary embodiments, the present invention is not limited to the foregoing exemplary embodiments. Various changes understandable by those skilled in the art can be made to the structures and details of the present invention within the scope of the present invention.

### REFERENCE SIGNS LIST

10 video coding device
11 block based affine transform motion compensated prediction control unit
20 video decoding device
21 block based affine transform motion compensated prediction control unit
101 transform/quantizer
102 entropy encoder
103 inverse quantizer/inverse transformer
104 buffer
105 predictor
106 multiplexer
201 de-multiplexer
202 entropy decoder
203 inverse quantizer/inverse transformer
204 predictor
205 buffer
1001 processor
1002 program memory
1003 storage medium
1004 storage medium
1050 block based affine transform motion compensated prediction controller
1051 control point motion vector setting unit
1052 control function added subblock motion vector derivation unit
2040 block based affine transform motion compensated prediction controller

What is claimed is:

1. A video coding device that performs video coding using a block based affine transform motion compensated prediction technique that includes a process of calculating a motion vector of each subblock using motion vectors of control points in a block, the video coding device comprising
a block based affine transform motion compensated prediction control unit which controls at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

2. The video coding device according to claim 1, wherein the block based affine transform motion compensated prediction control unit: increases the block size of the subblock in the case of controlling the block size of the subblock; limits the prediction direction to unidirectional in the case of controlling the prediction direction; and rounds the motion vector of the subblock to an integer motion vector in the case of controlling the motion vector precision.

3. A video decoding device that performs video decoding using a block based affine transform motion compensated prediction technique that includes a process of calculating a motion vector of each subblock using motion vectors of control points in a block, the video decoding device comprising
a block based affine transform motion compensated prediction control unit which controls at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

4. The video decoding device according to claim 3, wherein the block based affine transform motion compensated prediction control unit: increases the block size of the subblock in the case of controlling the block size of the subblock; limits the prediction direction to unidirectional in the case of controlling the prediction direction; and rounds the motion vector of the subblock to an integer motion vector in the case of controlling the motion vector precision.

5. A video coding method of performing video coding using a block based affine transform motion compensated prediction technique that includes a process of calculating a motion vector of each subblock using motion vectors of control points in a block, the video coding method comprising
controlling at least one of a block size, a prediction direction, and a motion vector precision of the subblock in the block subjected to the block based affine transform motion compensated prediction, using at least one of an image size, a prediction direction of the block, and a difference between the motion vectors of the control points in the block.

6. The video coding method according to claim 5, wherein: the block size of the subblock is increased in the case of controlling the block size of the subblock; the prediction direction is limited to unidirectional in the case of controlling the prediction direction; and the motion vector of the subblock is rounded to an integer motion vector in the case of controlling the motion vector precision.

7-10. (canceled)
